(19) United States
(12) Patent Application Publication
(10) Pub. No.: US 2013/0246089 A1
(43) Pub. Date: Sep. 19, 2013

(54) METHOD FOR DISPLAY AND NAVIGATION TO CLINICAL EVENTS

(71) Applicants: Brian D. Gross, North Andover, MA (US); Dimitri Shvartsman, Belmont, MA (US); David Youngjin Kim, Roxbury Crossing, MA (US); Elizabeth J. Zengo, Hudson, NH (US)

(72) Inventors: Brian D. Gross, North Andover, MA (US); Dimitri Shvartsman, Belmont, MA (US); David Youngjin Kim, Roxbury Crossing, MA (US); Elizabeth J. Zengo, Hudson, NH (US)

(73) Assignee: KONINKLIJKE PHILIPS ELECTRONICS N.V., EINDHOVEN (NL)

(21) Appl. No.: 13/812,993

(22) PCT Filed: Jul. 12, 2011
(86) PCT No.: PCT/IB2011/053107

§ 371 Date: Feb. 22, 2013

Related U.S. Application Data
(60) Provisional application No. 61/370,249, filed on Aug. 3, 2010.
(60) Provisional application No. 61/410,120, filed on Nov. 4, 2010.

(51) Int. Cl. G06F 19/00

(52) U.S. Cl. CPC G06F 19/3406
USPC 705/2

(57) ABSTRACT

Visual renderings of medical events and alarms are generated by a display controller (114) and displayed on a display (42, 42′). The display controller is programmed to receive data indicative of physiological or clinical status versus time of a selected patient from a data store (16, 16′) and detect events and/or alarms. An event object is created for each event/alarm segment, including a bar (72, 74) extending along a time line (88). Each event object is labeled using at least one of color coding, height coding, color intensity coding, and character coding.

The present application relates to medical monitoring and clinical data display devices for monitoring the physiological condition of a patient. It finds particular application in improving the display and navigation to events of interest containing patient information on a patient monitoring device, central station monitor, single or multi-patient dashboard display device and will be described with particular reference thereto.

Presently, a limited amount of physiological data is capable of being displayed on a patient monitoring device. When an alarm is triggered or an event is detected due to a measured change in the physiological condition of a patient or clinical event, data relating to the alarm or event is displayed. To better diagnose a current physiological state of the patient, the clinician views patient data leading up to and during the alarm or event from a variety of sensors. Monitors typically display current data and store past data. One way to display past data is in the format of an electronic strip chart. That is, data, such as that from an electrocardiogram (ECG) or other physiologic waveform, is displayed along a time line that can be extended back minutes, hours, or even days. With an average heart rate of about 70 beats per minute, scanning this number of heartbeats for events or alarms can be time consuming. Moreover, the occurrence of an alarm or event typically supersedes the display of other physiological data and events that occurred prior to or simultaneously with the alarm.

The present application provides a new and improved method of display and navigation of patient information on a patient monitoring device, which overcomes the above-referenced problems and others.

In accordance with one aspect, a device for generating visual renderings of medical events and alarms is provided. The device includes a display controller and a display on which visual renderings are displayed. The display controller is programmed to receive data of a selected patient from a data store. The data includes physiological information indicative of physiological status along a time line and segments along the time line corresponding to events and/or alarms. The display controller is programmed to create an event object for each event/alarm segment, including a bar extending along the time line. The display controller is also programmed to label each event object using at least one of color coding, height coding, color intensity coding, and character coding. Finally, the display controller is programmed to control the display in order to display the labeled bar and the physiological data.

In accordance with another aspect, a medical monitoring system is provided. The system includes a control processor and a plurality of medical sensors, which sense the physiological status of a patient. The control processor is programmed to compare the physiological status from the medical sensors with at least one of an event and alarm criteria to detect when along a time line each event and/or alarm occurs. The control processor is also programmed to store physiological information indicative of the physiological status, as well as the history related to the history of the event including event creation, event annunciation, user or system response to the annunciation, and event conclusion, along the time line and segments of the time line corresponding to the occurrence of the event and/or alarm in a data store.

In accordance with another aspect, a method for generating visual renderings of medical events and alarms is provided. The method includes receiving data of a selected patient, which includes physiological information indicative of physiological status along a time line and segments along the time line corresponding to events and/or alarms. An event object is created for each event/alarm segment including a bar extending along the time line. Each event object is labeled using at least one of color coding, height coding, color intensity coding, and character coding. The labeled event objects are displayed on a display.

In accordance with another aspect, a method of grouping events is provided. The method includes collecting alarms and events from at least one other medical device or clinical system and presenting alarms and events of similar cause, body system, or event context, grouped together under a single hierarchical representation.

One advantage resides in a hierarchal display of patient event data, allowing multiple physiological parameters and associated events and alarms to be displayed over an extended time range.

Another advantage resides in the improved navigation of patient data to locate and evaluate clinical events.

Another advantage resides in the concurrent display of system information (e.g. alarm state, confidence level of an event, etc.) and physiological events.

Another advantage resides in the improved disclosure to the user as “why”, “where”, “who” and “how” the event or alarm was addressed or acknowledged and responded to, in the system.

Still further advantages of the present invention will be appreciated to those of ordinary skill in the art upon reading and understand the following detailed description.

The invention may take form in various components and arrangements of components, and in various steps and arrangements of steps. The drawings are only for purposes of illustrating the preferred embodiments and are not to be construed as limiting the invention.

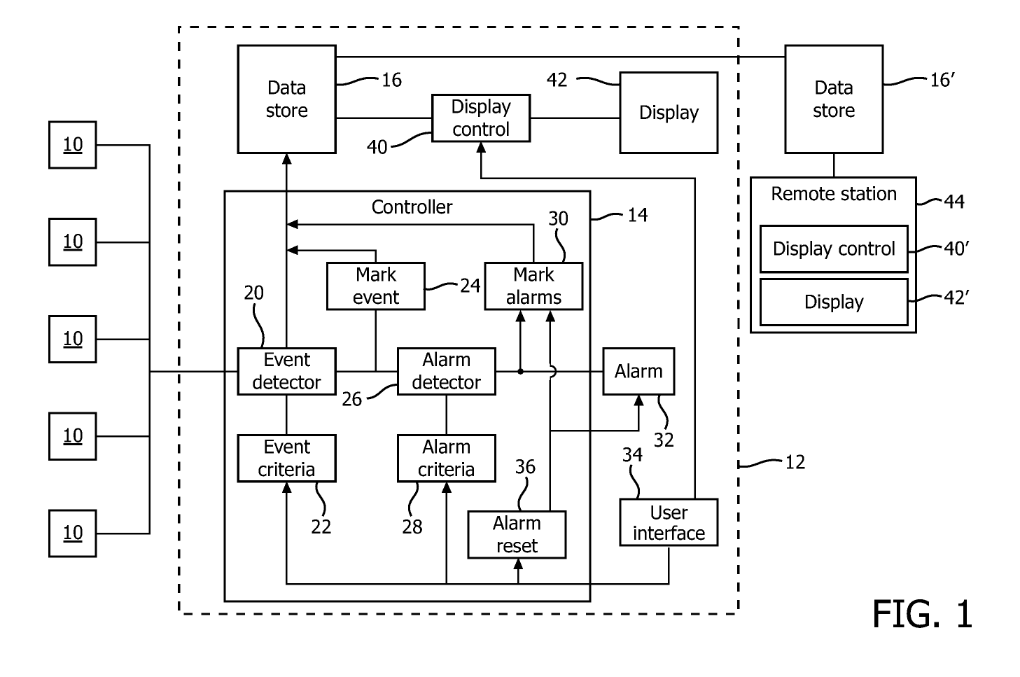

FIG. 1 is a diagrammatic illustration of a patient monitoring device in accordance with the present application.

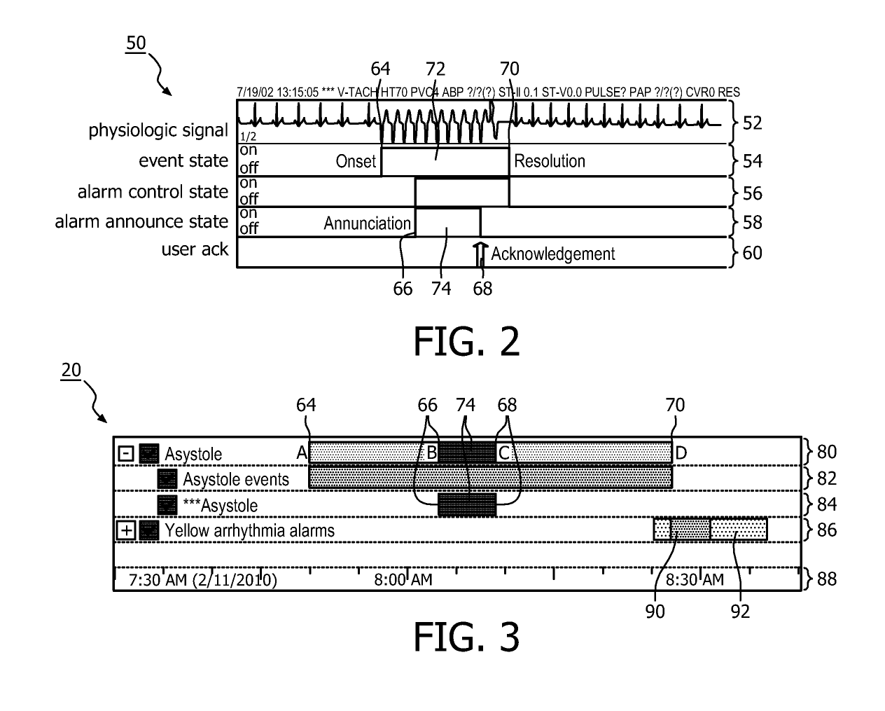

FIG. 2 is a diagrammatic illustration of event attributes in relation to physiological data.

FIG. 3 is one embodiment of a display of a patient monitoring device with hierarchal grouping of patient events.

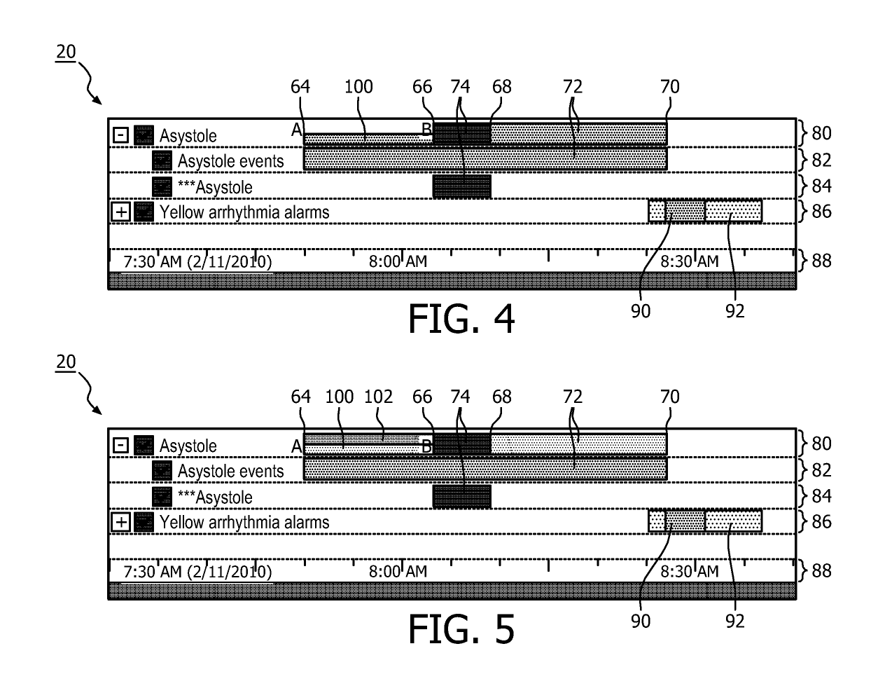

FIG. 4 is another embodiment of a display of a patient monitoring device where the alarm state is represented through the event object height.

FIG. 5 is another embodiment of a display of a patient monitoring device where the alarm state is represented with a darker line in the event object.

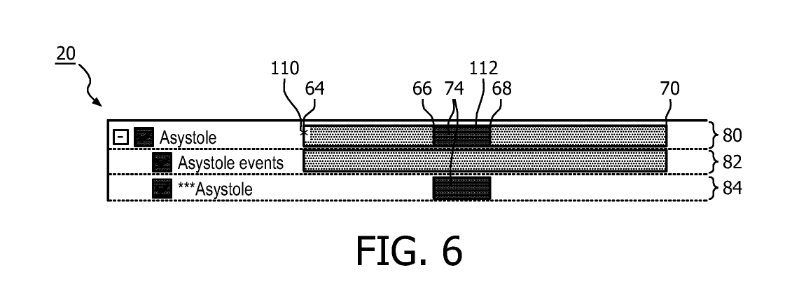

FIG. 6 is another embodiment of a display of a patient monitoring device where the confidence level of the event is represented by the height of a vertical bar and a unique terminator mark presents additional information.

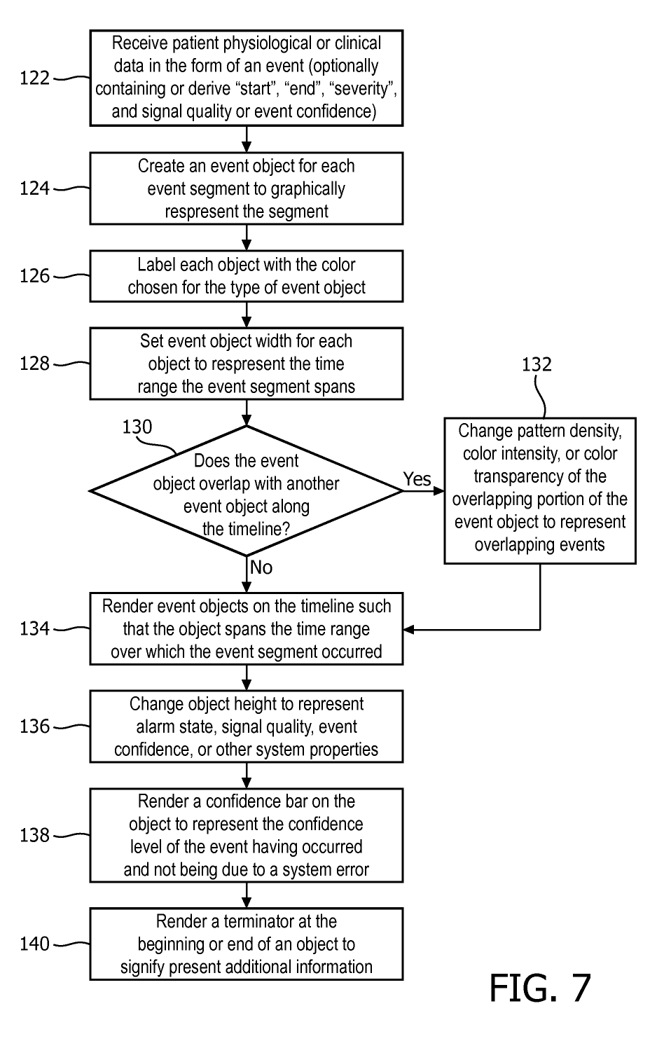

FIG. 7 is a flow chart diagram of the display of patient events on a display of a patient monitoring device.

With reference to FIG. 1, a patient (not shown) is monitored by various medical monitoring devices or sensors, or clinical information systems 10 that measure physiological parameters of the patient and generate physiological or clinical data indicative thereof. These medical monitoring devices or clinical information 10 may include ECG sensors, IV fluid pumps, blood pressure sensors, SpO2 sensors, pulse sensors, thermometers, respiratory sensors, gas sensors, therapy administration events and clinical order or administration transactions, and the like. Of course, other medical monitoring devices 10 can be associated with a patient, and not all of the above-mentioned medical monitoring devices 10 need be associated with a patient at any given time. It should be appreciated that while five medical or clinical devices 10 are illustrated, fewer or more medical monitoring devices are contemplated. As used herein, medical monitoring devices 10 signify data sources indicating patient health, laboratory results, patient treatment (e.g., administration of medication), or the like. Electronics for receiving signals from the medical monitoring devices 10 and for optionally performing signal processing on such signals are embodied in the illustrated embodiment as a patient monitoring device 12. The patient monitoring device 12 is frequently located near the patient, e.g. a bedside monitor, or centrally located in a nurse's station, or the like. The invention may also be practiced in data views available remote from the bedside and care unit via remote access to the system over the hospital LAN, intranet, or internet. It should also be appreciated that the medical monitoring devices 10 and the patient monitoring device 12 could also be embodied into a single device. The patient monitoring device 12, for example, may be a monitor that travels with the patient, such as the transmitter of an ambulatory patient worn monitoring system, or the like.

The medical monitoring devices 10 may be powered by battery, external AC power, or a combination of both. The physiological data can be communicated continuously or periodically. For a given patient, some data may be communicated continuously, such as EGG, and other data, such as blood pressure, periodically. The medical monitoring devices 10 transmit the generated physiological data via a body coupled network, Zigbee, Bluetooth, wired network, wireless network, or the like to a controller 14 of the patient monitoring device 12. The patient monitoring device 12 serves as a gathering point for the physiological data associated with the events and alarms measured by the medical monitoring devices 10, and provides storage for the monitored data, as well as relevant time and clinical context to the application, in a data store 16 or other onboard or remote electronic memory. The data store 16 contains both per-patient entries and, based on the application, system wide events.

The controller 14 receives the generated physiological data from the medical monitoring devices 10. Additionally the controller 14 receives data from the alarm and event sources 10, related to how the system or user acknowledged the alarm or event which is also saved in the data store 16. The controller 14 includes an event detector 20, such as a processor, algorithm or unit which compares the data with event criteria from an event criteria memory unit 22. Events are physiological data variations in excess of selected criteria. When an event is detected, an event marking unit 24 marks the beginning or onset time and end or resolution time of each event as well as how the event was acknowledged , by whom and where. The data and the event markings are stored together in the data store 16. An alarm detector 26 such as an algorithm or unit, compares the data with alarm criteria from an alarm criteria memory unit 28. If an alarm condition is detected an alarm marking unit or algorithm 30 marks a beginning or annunciation time which is stored in the data store 16 in conjunction with the data, as well as how the alarm was acknowledged, by whom and where. The detection of the alarm condition also triggers an alarm 32, such as an auditory and/or visual alarm. A clinician through a user interface 34 acknowledges the alarm which causes an alarm reset unit 36 to control the alarm marker 30 to mark the alarm acknowledgment time in the stored data and resets the alarm 32. The controller 14, in one embodiment, includes one or more processors programmed to perform the above described operations. In another embodiment, the controller 14 includes a plurality of processors or units, each designed to function as described above.

A display controller 40 which may be part of the controller 14 is controlled by the user interface 34 to retrieve the stored physiological data the event onset times, the annunciation times, the acknowledgement times, and the resolution times from the data store 16 and format the retrieved information for display on a display 42 in a manner which facilitates easy identification and analysis of events and alarms. Rather than storing the data on the monitor 12, the data can be stored in a remote memory 16′. A work station 44 can include a display controller 40′ and a display 42′. Display 42′ may be embodied in remote applications away from the bedside and care unit and via remote access to the system over the hospital LAN, intranet or internet. Several embodiments of suitable display formats which the display controller 40 is programmed or controlled to generate are illustrated in conjunction with FIGS. 2-6 below.

Each event contains event attributes describing the event type (single physiologic parameter, multiple physiologic conditions, system conditions, etc.), event onset time, annunciation time, acknowledgement time, and resolution time. The event onset time is the time identified when the event is first detected by the event detector 20. The annunciation time is the time when the alarm detector 26 announces the presence of the alarm level to the alarm 32 and causes the alarm 32 to become active (not turned off). The acknowledgement time is the time when the event is acknowledged either by the clinician, or the host system. The resolution time is the time when the event is no longer active.

With reference to FIG. 2, a diagrammatic representation 50 of the relationship between event attributes and physiological data 52 is shown. The physiological data 52 is shown with system states 54, 56, 58, 60. A change in the physiological data 52 is identified by the event detector 20 and signaled as the onset time 64. Following detection of the onset of the physiological event, the alarm is signaled as the annunciation time 66. The alarm continues as long as the alarm control 56 is set to on, or until the system receives acknowledgement by the user or another stimulus, signaled as the acknowledgement time 68. The end of the physiological event is identified by the event detector 20 and signaled as the resolution time 70 and is independent from acknowledgment activity. An event duration 72 is a time range beginning with detection of the event at the onset time 64 and concluding with the detection of the end of the event at the resolution time 70. The alarm duration 74 is the time range beginning with the annunciation time 66 and concluding with acknowledgement of the alarm at the acknowledgement time 68.

As previously mentioned, the display controller 40 controls the display 42 to retrieve and display the events received and stored by the various medical monitoring devices and clinical systems 10. With reference to FIG. 3, the display object is rendered with rows of events collapsed to show the highest level data view 80. In the case where the subgroups contain multiple events, the expanded rows 82, 84 are rendered to represent the event which exists below the higher level grouping 80. This representation, in one embodiment, is based on color intensity to show over lapping events, each event attribute being a different color. In FIG. 3, color transparency is used to show overlapping events. Event objects are overlaid to symbolize the occurrence of events in the timeline. Event onset time 64 of the top row “Asystole” condition is depicted by “A”, annunciation time 66 is depicted by “B”, acknowledgement time 68 is depicted by “C”, and resolution time 70 is depicted by “D”. Overlaid events can be expanded such that each event is rendered in a separate row 82, 84 over the same time range or collapsed into a high level data view 80,86, in which multiple events are rendered as a single collapsed row. An “Asystole” bar 80 is expanded into the sub group “Asystole Events” 82 and “*** Asystole Alarms” 84. A collapsed “Yellow Arrhythmia Alarms” 86 is also shown. In the case where the sub groups 82, 84 contain multiple events, the collapsed rows are rendered to represent the event which exists below the higher level grouping. “Asystole” 80 is rendered with rows of events collapsed 82, 84 to show the highest level data view 80.

Each object rendered on the display spans the same time range. Each event segment is rendered as an object in a row on the display 20, in the assigned color and color intensity, over the range of time that the event segment occurred.

Event segments that overlap in time are rendered by changing the color intensity, color transparency, or a combination thereof of the overlapping portion. In the preferred embodiment, color intensity is changed to show overlapping events, each event segment being a different color as well. Other embodiments include the use of color transparency or event row height to show overlapping events. In the Yellow Arrhythmia Alarms, two overlapping events/alarms 90, 92 are both visible due to the use of color transparencies. An underlying event/alarm can be seen through the overlapping event/alarm as an area of greater color intensity.

With reference to FIG. 4 an event object 100 prior to the alarm object 74 is displayed with reduced in height compared to the rest of the Asystole event object 72, indicating that the sourcing parameter for the alarm object 74 was at reduced confidence between point “A” and point “B”. In prior provisional patent application US 61/152,979, a system to derive a level of confidence with an event or alarm based on signal quality of the related input signals, is proposed. This indicates to the user why the alarm did not announce at the onset time 64 when it was detected by the arrhythmia detection algorithm. It should be noted that in the figure the confidence in the event is rendered to be constant over time but can be a variable function over time.

In FIG. 5, the event object 100 prior to the alarm object 74 is rendered with a darker line 102 to represent that the alarm for this event is paused. This information indicates why the alarm did not announce at the beginning of the event (“A”), but rather announced later when the alarm was turned on (B).

With reference to FIG. 6, a unique commencement mark 110 at the beginning 64 of the event indicate a self terminating event (condition corrected itself), such as a latched alarm, from a user acknowledged alarm, and what acknowledgement was detected (pause alarms, acknowledge alarms, change limits, etc.). The unique terminator mark 110 at the end 68 also provides a target for the user to obtain access to annotations created by event. The height of a confidence bar 112 can also indicate a relative confidence on the validity of the event from such a level of confidence system. A unique mark can alternatively be utilized to indicate an event with low confidence. A family of marks can be used to indicate a variety of useful information.

In operation, one or more physiological parameters of a patient are monitored and displayed in real time on a monitor display. When a clinician wants to review the physiological parameters leading up to the current time, the clinician moves back through the data. In one embodiment, the clinician scrolls backward through the data. The color or other graphical depiction of the events and the alarms helps the clinician to find the pertinent time periods. Hovering a tool tip over a selected time range, in one embodiment, causes the graphical event and alarm depictions to be displayed for the highlighted time period. Clicking sets the time focus to the selected time and causes all events in the selected time focus to be displayed. Clicking can also be used to expand and collapse the various event and alarm bars in the selected time focus.

FIG. 7 illustrates operation of the display controller 40 or 40′ of the patient monitoring or clinical information system device 12 or 44. In a step 122, the device 12 receives physiological or clinical data and compares the data with event criteria. In a step 124, an event object is created to graphically represent each detected event. In a step 126, each event object is labeled with the color assigned to that event segment type. In a step 128, the event object width (length) is set to represent the time range the event segment spans. In a step 130, each event attribute is checked to see if it overlaps with another event attribute in time. If an event attribute overlaps in time with another event attribute 132, then the color intensity or color transparency of the overlapping portion of the event object is changed to represent that the event segments overlap. In a step 134, the overlapping and non-overlapping event objects are rendered along the timeline spanning the correct time range. Optionally, in a step 136, the object height is changed to represent the alarm enablement state, signal quality, or other system properties. Optionally, in a step 138, a confidence bar is rendered on the object to represent the confidence level of the event having occurred and not being due to a system error. Optionally, in a step 140, a unique terminator mark is rendered at the beginning or end of an object to signify or present event segments with additional information.

The invention has been described with reference to the preferred embodiments. Modifications and alterations may occur to others upon reading and understanding the preceding detailed description. It is intended that the invention be constructed as including all such modifications and alterations insofar as they come within the scope of the appended claims or the equivalents thereof.

1. A device for generating visual renderings of medical events and alarms, the device comprising:
a display on which the visual renderings are displayed;
a display controller programmed to:
receive from a data store data of a selected patient which includes physiological or clinical data indicative of physiological status along a time line and segments along the time line corresponding to events and/or alarms;
create an event object for each event/alarm segment including a bar extending along the time line;
label each event object using at least one of color coding, height coding, color intensity coding, and character coding; and
control the display to display the labeled bar and the physiological or clinical data.

2. A medical system comprising:
a control processor programmed to:
compare the physiological status from medical sensors or clinical information with at least one of an event and alarm criteria to detect when along the time line each event and/or alarm occurs;
store physiological or clinical information indicative of the physiological status along the time line and segments of the time line corresponding to the occurrence of the event and/or alarm in the data store; and
the device for generating visual renderings of medical events and alarms according to claim 1.

3. The system according to claim 2, wherein the control processor is further programmed to determine:
an onset time signifying a time when the event is first detected by the control processor;
an annunciation time signifying when the control processor causes an alarm to announce a presence of the event;
an acknowledgement time signifying when the alarm is acknowledged by a user; and
a resolution time signifying a time when the event is no longer active.

4. The system to according to claim 2, wherein the display controller is further programmed to:
label each event object using color coding, such that the color of the bars represents a property of the physiological or clinical information represented by the event object.

5. The system according to claim 2, wherein the display controller is further programmed to:
label each event object using color intensity coding, such that a change in the color intensity represents overlapping events or a property of the physiological or clinical information represented by the event object.

6. The system according to claim 2, wherein the display controller is further programmed to:
label each event object using height coding, such that a height of the bars represents a property of the physiological or clinical information represented by the event object.

7. The system according claim 2, wherein the display controller is further programmed to
label each event object using character coding, such that a character symbolizes a property of the physiological or clinical information represented by the event object.

8. The system according claim 2, wherein the display controller is further programmed to allow user interaction with the bar of each event object, wherein:
a series of related event objects are displayed on the display as a high level data view, wherein each related event object is represented in a single row;
the high level data view is expandable, such that each event object of the high level data view is displayed as separate sub-rows;
the high level data view is collapsible, such that sub-rows are collapsed into the single row.

9. The system according to claim 2, wherein the display controller is further programmed to:
determine a confidence or signal quality level of each event object, wherein the confidence or signal quality level indicates a relative confidence of the validity of the event represented by the event object;
label at least one event object using a confidence coding to depict a confidence level of the event represented by the event object.

10. The system according to claim 2, wherein the control processor is further programmed to determine additional event data not present in the physiological status from the medical sensors or clinical information in order to render the event.

11. A method for generating visual renderings of medical events and alarms, the method comprising:
receiving data of a selected patient which includes physiological or clinical information indicative of physiological status along a time line and segments along the time line corresponding to events and/or alarms;
creating an event object for each event/alarm segment including a bar extending along the time line;
labeling each event object using at least one of color coding, height coding, color intensity coding, and character coding;
displaying the labeled event objects.

12. The method according to claim 11, further including:
comparing physiological status from medical sensors with at least one of an event and alarm criteria to detect when along the time line each event and/or alarm occurs,
storing physiological or clinical information indicative of the physiological or clinical status along the time line and segments of the time line corresponding to the detected event and/or alarm.

13. The method according to claim 11, further including:
determining:
an onset time signifying a time when the event is first detected;
an annunciation time signifying when an alarm announces a presence of the event;
an acknowledgement time signifying when the alarm is acknowledged; and
a resolution time signifying a time when the event is no longer active.

14. The method according to claim 11, wherein labeling each event object includes at least one of:
using color coding or color intensity coding, such that the color or color intensity of each event object represents a property of the physiological or clinical information represented by the event object;
using height coding, such that height represents a property of the physiological or clinical information represented by the event object; and
using character coding, such that a character symbolizes a property of the physiological or clinical information represented by the event object.

15. The method according to claim 11, further including:
displaying a series of related event objects in a single row as a high level data view;
expanding the high level data view is to display the event objects of the high level data view in a plurality of rows;
collapsing the plurality of rows back into the single row.

16. The method according to claim 11 further including:
determining a confidence level of each event object, the confidence level being indicative of a relative confidence of a validity of the event represented by the event object;
labeling at least one event object to denote a level of confidence in a validity of the measures creating the event represented by the event object.

17. The method according to claim 11, further including:
determining additional event data not present in the physiological status from the medical sensors or clinical information in order to render the event.

18. A non-transient computer readable medium carrying software for controlling one or more processors to perform the method according to claim 11.

19. A display generated by the device according to claim 1, the the display comprising:
physiological or clinical data line;
a timeline;
event objects including bars extending along the timeline, the bars having at least one of color coding, height coding, color intensity coding, and character coding.

20. The display according to claim 19, further including:
an onset time notation signifying a time when the event is first detected by the control processor;
an annunciation time notation signifying when an alarm to announces a presence of the event;
an acknowledgement time notation signifying when the alarm is acknowledged by a clinician; and
a resolution time notation signifying a time when the event has been resolved.
